(19) United States
(12) Patent Application Publication
(10) Pub. No.: US 2010/0302452 A1
(43) Pub. Date: Dec. 2, 2010

(54) METHOD AND APPARATUS FOR DETECTING A TRANSITION BETWEEN VIDEO SEGMENTS

(75) Inventor: Gerrit Cornelis Langelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/599,105

(22) PCT Filed: May 5, 2008
(86) PCT No.: PCT/IB08/51734

§ 371 Date: Nov. 6, 2009

(30) Foreign Application Priority Data
May 8, 2007 (EP) 07107666.5

(51) Int. Cl. H04N 5/14

(52) U.S. Cl. 348/700; 348/E05.062

(57) ABSTRACT

A first transition between a first video segment and a second video segment is detected by a first detector (105). A second transition is detected by a second detector (107). The first and second detectors (105, 107) are different. The outputs of the first and second detectors (105, 107) are compared (109). The reliability of the second method is determined by comparing the transition detected by the first detector (105) with the transition detected by the second detector (107). At least the second transition is used to determine a final transition if the second method is determined to be reliable. The second transition is not used to determine the final transition if the second method is determined to be unreliable.

### FIELD OF THE INVENTION

The present invention relates to method and apparatus for detecting a transition between video segments. In particular, but not exclusively, it relates to detecting and verifying the transition (or boundary) between a program and a commercial block.

### BACKGROUND OF THE INVENTION

Simple commercial detection algorithms, for example those using black-frame and audio pressure features to detect the transitions between a TV program and a commercial block are well known. It has been found that these are sometimes inaccurate, for example new items or program intros can be mistaken and merged into the commercials. Therefore, as well as the commercials, portions of the program may be skipped.

Many channels include a logo displayed in a corner of the screen during the TV program. These logos do not appear during commercials. Therefore, some known commercial block detectors use logo detection to establish a transition between the program and the commercial block. These have also proven to be inaccurate as logos are not always properly overlaid during live events, boundaries are not known, some channels do not use logos, transparent logos cannot be detected on a white background etc.

To improve the performance of such commercial block detectors some use logo presence detection is utilized to suppress for example black-frame or letterbox detections with logos on them. However, these cannot deal with improperly overlaid logos by broadcasters or misdetections of the logo itself.

### SUMMARY OF THE INVENTION

The present invention seeks to provide a technique for accurately detecting and hence verifying the transition between video segments.

This is achieved according to a first aspect of the present invention by a method for detecting a transition between a first video segment and a second video segment, the method comprising the steps of: detecting a first transition between a first video segment and a second video segment by a first detection method; detecting a second transition between said first video segment and said second video segment by a second detection method, said first detection method being different from said second detection method; determining whether said second method is reliable by comparing said first transition with said second transition; and using at least said second transition to determine a final transition if said second method is determined to be reliable and not using said second transition to determine said final transition if said second method is determined to be unreliable.

This is also achieved according to a second aspect of the present invention by an apparatus for detecting a transition between a first video segment and a second video segment, the apparatus comprising: a first detector for detecting a first transition between a first video segment and a second video segment; a second detector for detecting a second transition between said first video segment and said second video segment, said first detector being different to said second detector; and a comparator for determining whether said second method is reliable by comparing said first transition with said second transition and using at least said second transition to determine a final transition if said second method is determined to be reliable and not using said second transition to determine said final transition if said second method is determined to be unreliable.

Certain methods either detect transitions in certain content very well or not well at all, e.g. logo detectors. By comparing the transitions detected with such a method with the transitions detected with another method, it can be determined whether it is advisable to use the second method to determine the final transitions or not.

In an embodiment of the present invention, the second detection method comprises a simple logo detector and with incorporation of a first detection method, the system can easily correct for improperly overlaid logos by broadcasters or misdetections of the logo detector. If the logo detections are reliable the boundaries can be tuned using logo and other information from the first detection method to obtain more accurate boundaries.

Said final transition may be based solely or predominantly on said second transition if said second method is determined to be reliable.

Said final transition may be determined by using said second transition to refine said first transition.

In an embodiment of the present invention, the second detection method is determined as reliable by comparing start and/or end times of the first and/or second video segments determined by the first and the second detection methods; determining a ratio of the differences between corresponding start and/or end times of the first and second video segments; and determining the second detection method reliable if the determined ratio of differences is below a threshold value.

Alternatively, the second detection method is determined as reliable by determining a ratio of a corrected duration of the first video segments detected by the second detection method over the total duration of the video stream of first and second video segments; and determining the second detection method reliable if the determined ratio is above a second threshold value. Alternatively, the second detection method is determined as reliable by determining a ratio of a corrected duration of the first video segments detected by the second detection method over a duration of the corresponding first video segments detected by the first detection method; and determining the second detection method reliable if the determined ratio is above a third threshold value.

Reliability of the second detection method may be determined by the any one of the above ration or any combination thereof.

### BRIEF DESCRIPTION OF DRAWINGS

For a more complete understanding of the present invention, reference is made to the following description in conjunction with the accompanying drawings, in which:

FIG. 1 is a simplified schematic of apparatus according to an embodiment of the present invention;

FIG. 2 is a flowchart of the comparator according to the embodiment of the present invention; and

FIG. 3(a), (b) and (c) are graphical representations of an example of the output of the detectors and comparator of the apparatus of FIG. 1.

### DETAILED DESCRIPTION OF AN EMBODIMENT OF THE INVENTION

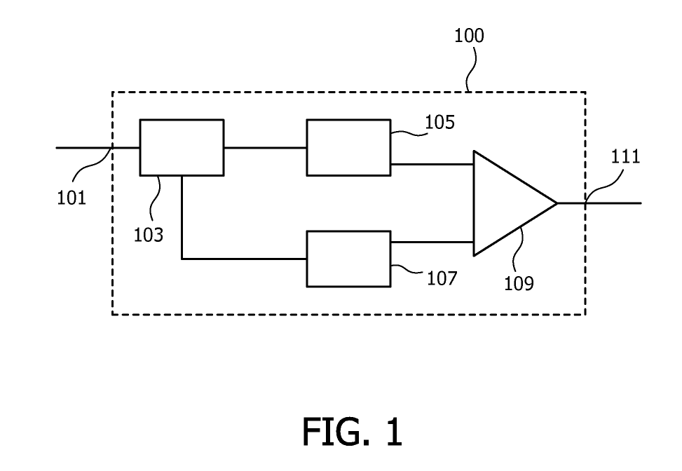

With reference to FIG. 1, the apparatus 100 comprises an input terminal 101 connected to the input of a demultiplexer 103. The outputs of the demultiplexer 103 are connected to a first detector 105 and a second detector 107. The outputs of the first and second detectors 105, 107 are connected to respective inputs of a comparator 109. The output of the comparator 109 is connected to an output terminal 111 of the apparatus 100. The outputs of the detectors 105, 107 may be stored in a memory device or database (not shown here) for later comparison and/or processing.

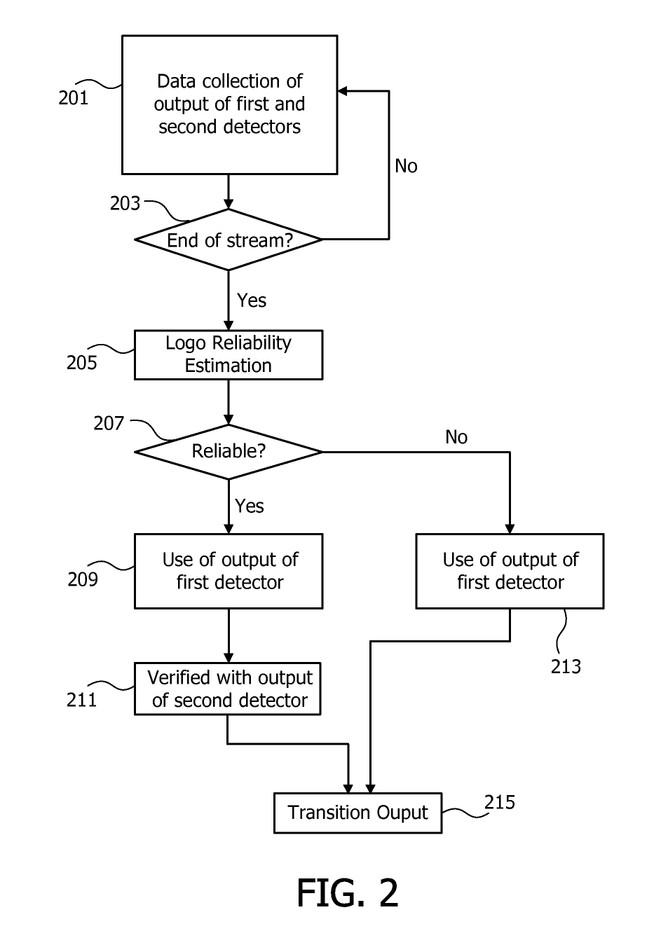

With reference to FIG. 2, operation of the apparatus will be described. An audiovisual data stream is provided on the input terminal 101 of the apparatus 100. The data stream is demultiplexed by the demultiplexer 103. The audio and/or video output is fed to a first detector 105. The first detector 105 may comprise an audio cut-silence detector in which case audio presentation time stamps and signal power of the audio are processed to provide audio feature data. Video feature data is also extracted. Transitions between a first video segment and a second video segment are detected on the basis of the extracted audio and video feature data. Other known techniques for detecting the transition can be utilized such as black-frame detection, letterbox change, monochrome frame, audio power drop etc. In this way the first detector 105 detects separation points based on black frames, audio drops etc. These points can occur during a normal program as well as at the transition between the normal program and the commercial block. Therefore, in order to determine whether these separation points are in fact a transition between a normal program and a commercial block, a set of separation points have to meet certain requirements. The separation points of this set of points are merged and result in two transition points, the first and the last separation point of this set representing the start and end of a commercial block, i.e. the transition between the normal program and the commercial block. The first detector 105 generates a plurality of candidate transitions between video segments, i.e. transitions between programs and commercials, step 201, for the input data stream.

The second detector 107 receives the demultiplexed video presentation time stamps. The second detector 107 divides this into a plurality of frames. Each frame is analyzed to detect a graphical object such as a logo or recognized text or the like. The second detector 107 outputs a plurality of logo free episodes, namely an indication of the transition between appearance and/or disappearance of a graphic object (logo), step 201.

When the end of the data stream, step 203, is detected, the comparator combines the output of detector 105, 107 and generates a final list of the start and end times (transitions) of each video segment, i.e. commercial block start and end times.

This is achieved by estimating the reliability of the second detection detector 107, step 205. If the second detector is determined reliable, step 207, transitions found by the second detector 107 are processed and output, step 209, 211, 215 and combined with transitions detected by the first detector 105.

If the second detector 107 is determined unreliable, step 207, transitions found by the first detector 105 are processed only, step 213 and output, step 215.

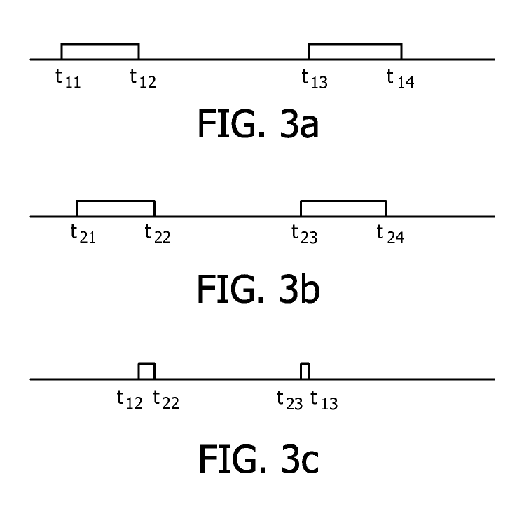

Determination of reliability of the second detector 107 will now be described in more detail with reference to FIGS. 3(a), (b) and (c).

FIG. 3(a) is a graphical representation of the output of the first detector 105;

FIG. 3(b) is a graphical representation of the output of the second detector 107;

FIG. 3(c) is a graphical representation of a comparison of the output shown in FIGS. 3(a) and 3(b).

As mentioned above, the comparator first checks whether the second detector 107 (logo detector) is reliable or not. In carrying out such a check, in the event that some broadcasters forget to overlay the logo after a commercial break, especially during live events, and in the event that some channels (almost) always overlay a logo, also during commercial breaks, the logo data is not useable for commercial block detections. The transitions t₁₁, t₁₂, t₁₃, t₁₄, t₂₁, t₂₂, t₂₃, t₂₄ of FIGS. 3(a) and 3(b) output by the first and second detectors 105, 107 are the transitions detected between the first and second video segments. For example, transitions t₁₁, t₁₃ represent the start of a commercial block detected by the first detector 105; transitions t₁₂, t₁₄ represent the end of commercial blocks detected by the first detector 105; transitions t₂₁, t₂₃ represent the start of a logo free episode detected by the second detector 107; and transitions t₂₂, t₂₄ represent the end of a logo free episode detected by the second detector 107.

The ratio between the duration of logo free episodes t₂₁ to t₂₂ and t₂₃ to t₂₄ outside the detected commercial blocks and the video duration is calculated as follows:

Ratio_A=V1LogoFreeNoOverlap*100%/VideoDuration (1)

i.e. the ratio of commercial blocks detected by the first detector having no overlap with that detected by the second (logo free episodes) over the duration of the video stream.

In general this ratio is small (<5%), since the logo normally disappears only 20 seconds before start of a commercial block and appears 20 seconds after the end of a commercial block. However, if the logo detector fails for short periods because of static content or “invisible transparent logos on a white background” this percentage can slightly be higher. If this ratio exceeds 15% the broadcaster probably forgot to overlay the logos for a longer period.

Next, the ratio between the total duration of the corrected logo free episodes against the video duration is calculated:

Ratio_B=CorrLogoFreeDuration*100%/VideoDuration (2)

wherein CorrLogoFreeDuration is the corrected logo free episode duration in which durations considered too short or too long are discarded.

If this ratio is very small (less than 3%) the logo is probably always visible, i.e. it is also visible on commercials. Or the recording/broadcast do not contain any commercials.

The total duration of the corrected logo free episodes (second detector) against the total duration of the detections of the first detector is compared:

Ratio_C=CorrLogoFreeDuration*100%/CBV1Duration (3)

wherein CorrLogoFreeDuration is the corrected logo free episode duration in which durations considered too short or too long are discarded and wherein CBV1Duration is the duration of the commercial block detected by the first detector (FIG. 3(a)).

If this ratio is less than 45% the logo free episodes are significantly shorter than the commercial blocks detected by the first detector. This happens when logos are overlaid on some of the commercials, or commercials are interleaved with a lot of trailers with logos on them.

The Logo Free Episodes are therefore considered unreliable if:

(Ratio_A>NOOVERLAPRATIO) OR (RATIO_B<VIDDURATIONRATIO) OR (Ratio_C<CBV1RATIO) (4)

where, in the particular example above, NOOVERLAPRATIO equals to 15%, VIDDURATIONRATIO equals to 3% and CBV1RATIO equals to 45%. It can be appreciated that these threshold percentages are examples only and can be varied as appropriate. Otherwise the detected Logo Free Episodes are assumed to be reliable and used for fine-tuning the transitions detected by the first detector or at least to verify the transitions.

The candidate commercial blocks detected by the first detector may be used to verify the reliability of the logo detections. For example, the total duration of the logo free episodes against the total duration of the candidate commercial block detected by the first detector and/or compare the program duration against the total duration of the episodes where there is no overlap between a logo free episode and the candidate commercial blocks detected by the first detector.

If the logo detections of the second detector are considered not reliable the candidate commercial blocks detected by the first detector become the final transition and output of the apparatus. If the logo detections of the second detector are considered reliable, the transitions detected by the first detector are tuned using the logo detection of the second detector.

Although an embodiment of the present invention has been illustrated in the accompanying drawings and described in the foregoing detailed description, it will be understood that the invention is not limited to the embodiment disclosed, but is capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for detecting a transition between a first video segment and a second video segment, the method comprising the steps of:
detecting a first transition between a first video segment and a second video segment by a first detection method;
detecting a second transition between said first video segment and said second video segment by a second detection method, said first detection method being different from said second detection method;
determining whether said second method is reliable by comparing said first transition with said second transition; and
using at least said second transition to determine a final transition if said second method is determined to be reliable and not using said second transition to determine said final transition if said second method is determined to be unreliable.

2. A method according to claim 1, wherein said final transition is based solely or predominantly on said second transition if said second method is determined to be reliable.

3. A method according to claim 2, wherein said final transition is determined by using said second transition to refine said first transition.

4. A method according to claim 1, wherein said second detection method comprises the step of detecting said transition between a first video segment and a second video segment upon detection of a predetermined item.

5. A method according to claim 4, wherein said predetermined item is a graphical object.

6. A method according to claim 1, wherein said first detection method generates a first set of a plurality of candidate first video segments; and said second detection method generates a second set of a plurality of candidate first video segments.

7. A method according to claim 6, wherein the step of determining the reliability of said second detection method comprises the steps of:
comparing start and/or end times of said first and/or second video segments determined by said first and said second detection methods;
determining a ratio of the differences between corresponding said start and/or end times of said first and second video segments;
determining said second detection method reliable if said determined ratio of differences is below a threshold value.

8. A method according to claim wherein the step of determining the reliability of said second detection method comprises the steps of:
determining a ratio of a corrected duration of said first video segments detected by said second detection method over a total duration of a video stream of said first and second video segments; and
determining said second detection method reliable if said determined ratio is above a second threshold value.

9. A method according to claim 6, wherein the step of determining the reliability of said second detection method comprises the steps of:
determining a ratio of a corrected duration of said first video segments detected by said second detection method over a duration of said corresponding first video segments detected by said first detection method; and
determining said second detection method reliable if said determined ratio is above a third threshold value.

10. A computer program product comprising a plurality of program code portions for carrying out the method according to claim 1.

11. Apparatus for detecting a transition between a first video segment and a second video segment, the apparatus comprising
a first detector for detecting a first transition between a first video segment and a second video segment;
a second detector for detecting a second transition between said first video segment and said second video segment, said first detector being different to said second detector; and
a comparator for determining whether said second method is reliable by comparing said first transition with said second transition and using at least said second transition to determine a final transition if said second method is determined to be reliable and not using said second transition to determine said final transition if said second method is determined to be unreliable.

12. Apparatus according to claim 11, wherein said second detector comprises means for detecting said transition between a first video segment and a second video segment upon detection of a predetermined item.

13. Apparatus according to claim 11, wherein said comparator determines said final transition based solely or predominantly on said second transition if said second method is determined to be reliable.

14. Apparatus according to claim 13, wherein said comparator determines said final transition by using said second transition to refine said first transition.
